(19) United States
(12) Patent Application Publication
(10) Pub. No.: US 2023/0083850 A1
(43) Pub. Date: Mar. 16, 2023

(54) CRYPTOGRAPHIC SYSTEMS AND METHODS FOR DEVELOPMENT OF POOLS OF RANDOM NUMBERS

(71) Applicant: 7Tunnels Inc., Park City, UT (US)

(72) Inventor: Michael David Adams, Alpine, UT (US)

(21) Appl. No.: 17/802,122

(22) PCT Filed: Jan. 31, 2021
(86) PCT No.: PCT/US2021/015960

§ 371 Date: Aug. 24, 2022

Related U.S. Application Data
(60) Provisional application No. 62/983,935, filed on Mar. 2, 2020.

(51) Int. Cl. H04L 9/08; G06F 7/58; H04L 9/06

(52) U.S. Cl. CPC H04L 9/0869; G06F 7/588; H04L 9/0618

(57) ABSTRACT

Systems and methods include a random number pool in communication with a random number device. One or more sets of key data elements are developed using the random number device with one or more variables input into the random number device from the random number pool.

### PRIORITY CLAIM

This application claims the benefit of the filing date of U.S. Provisional Patent Application Ser. No. 62/983,935, filed Mar. 2, 2020, for “CRYPTOGRAPHIC SYSTEMS AND METHODS FOR DEVELOPMENT OF POOLS OF RANDOM NUMBERS,” the disclosure of which is hereby incorporated herein in its entirety by this reference.

### TECHNICAL FIELD

Embodiments of the present disclosure relate generally to cryptography and more specifically to encryption and decryption using data and structures similar to one-time pads.

### BACKGROUND

Cryptography is important for many types of communications including, but certainly not limited to, communications involving financial data, medical data, and government classified data. Many types of encryption are very difficult to decrypt, but can eventually be broken. Other types of encryption have significant vulnerabilities making decryption relatively easy. Conventional one-time pads are generally considered completely secure and unbreakable.

However, conventional one-time pads have a drawback related to how to convey the one-time pads to keep them secret. Moreover, for conventional one-time pads, the length of the key is equal to the length of the data to be encrypted, which may be unsuitable for high-bandwidth applications even if secure conveyance of the one-time pad is possible.

### BRIEF DESCRIPTION OF THE DRAWINGS

FIG. 1 is a block diagram of an encryption system using random number pools in accordance with embodiments of the disclosure.

FIG. 2 is a more detailed block diagram illustrating elements on a cryptography server using a random number pool in accordance with embodiments of the disclosure.

FIG. 3 illustrates processes for developing a random number pool in accordance with embodiments of the disclosure.

FIG. 4 is a block diagram illustrating a computing system for practicing embodiments of the present disclosure.

### DETAILED DESCRIPTION

In the following detailed description, reference is made to the accompanying drawings, which form a part hereof, and in which are shown, by way of illustration, specific example embodiments in which the present disclosure may be practiced. These embodiments are described in sufficient detail to enable a person of ordinary skill in the art to practice the present disclosure. However, other embodiments may be utilized, and structural, material, and process changes may be made without departing from the scope of the disclosure. The illustrations presented herein are not meant to be actual views of any particular method, system, device, or structure, but are merely idealized representations that are employed to describe the embodiments of the present disclosure. The drawings presented herein are not necessarily drawn to scale. Similar structures or components in the various drawings may retain the same or similar numbering for the convenience of the reader; however, the similarity in numbering does not mean that the structures or components are necessarily identical in size, composition, configuration, or any other property.

It will be readily understood that the components of the embodiments as generally described herein and illustrated in the drawings could be arranged and designed in a wide variety of different configurations. Thus, the following description of various embodiments is not intended to limit the scope of the present disclosure, but is merely representative of various embodiments. While the various aspects of the embodiments may be presented in drawings, the drawings are not necessarily drawn to scale unless specifically indicated.

Furthermore, specific implementations shown and described are only examples and should not be construed as the only way to implement the present disclosure unless specified otherwise herein. Elements, circuits, and functions may be shown in block diagram form in order not to obscure the present disclosure in unnecessary detail. Conversely, specific implementations shown and described are exemplary only and should not be construed as the only way to implement the present disclosure unless specified otherwise herein. Additionally, block definitions and partitioning of logic between various blocks is exemplary of a specific implementation. It will be readily apparent to one of ordinary skill in the art that the present disclosure may be practiced by numerous other partitioning solutions. For the most part, details concerning timing considerations and the like have been omitted where such details are not necessary to obtain a complete understanding of the present disclosure and are within the abilities of persons of ordinary skill in the relevant art.

Those of ordinary skill in the art would understand that information and signals may be represented using any of a variety of different technologies and techniques. For example, data, instructions, commands, information, signals, bits, symbols, and chips that may be referenced throughout this description may be represented by voltages, currents, electromagnetic waves, magnetic fields or particles, optical fields or particles, or any combination thereof. Some drawings may illustrate signals as a single signal for clarity of presentation and description. It will be understood by a person of ordinary skill in the art that the signal may represent a bus of signals, wherein the bus may have a variety of bit widths and the present disclosure may be implemented on any number of data signals including a single data signal.

The various illustrative logical blocks, modules, and circuits described in connection with the embodiments disclosed herein may be implemented or performed with a general purpose processor, a special purpose processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, such as a combination of a DSP and a microprocessor, a plurality of microprocessors, one or more microprocessors in conjunction with a DSP core, or any other such configuration. A general-purpose computer including a processor is considered a special-purpose computer while the general-purpose computer is configured to execute computing instructions (e.g., software code) related to embodiments of the present disclosure.

Also, it is noted that the embodiments may be described in terms of a process that is depicted as a flowchart, a flow diagram, a structure diagram, or a block diagram. Although a flowchart may describe operational acts as a sequential process, many of these acts can be performed in another sequence, in parallel, or substantially concurrently. In addition, the order of the acts may be re-arranged. A process may correspond to a method, a thread, a function, a procedure, a subroutine, a subprogram, etc. Furthermore, the methods disclosed herein may be implemented in hardware, software, or both. If implemented in software, the functions may be stored or transmitted as one or more instructions or code on computer-readable media. Computer-readable media includes both computer storage media and communication media including any medium that facilitates transfer of a computer program from one place to another.

It should be understood that any reference to an element herein using a designation such as “first,” “second,” and so forth does not limit the quantity or order of those elements, unless such limitation is explicitly stated. Rather, these designations may be used herein as a convenient method of distinguishing between two or more elements or instances of an element. Thus, a reference to first and second elements does not mean that only two elements may be employed there or that the first element must precede the second element in some manner. In addition, unless stated otherwise, a set of elements may comprise one or more elements.

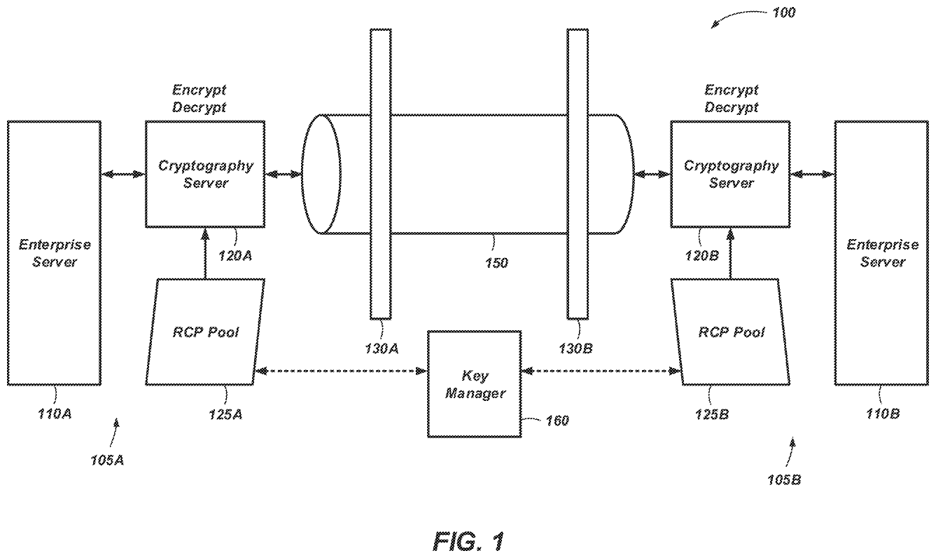

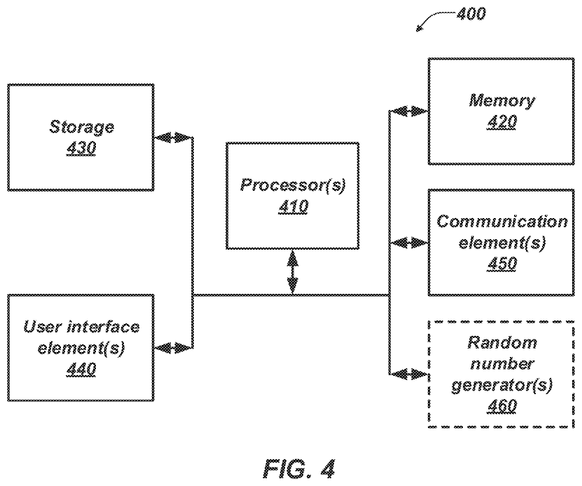

Elements described herein may include multiple instances of the same element. These elements may be generically indicated by a numerical designator (e.g. 110) and specifically indicated for a given instantiation by the numerical indicator followed by an alphabetic designator (e.g., 110A) or a numeric indicator preceded by a “dash” (e.g., 110-1). For ease of following the description, for the most part element number indicators begin with the number of the drawing on which the elements are introduced or most fully discussed. Thus, for example, element identifiers on a FIG. 1 will be mostly in the numerical format lxx and elements on a FIG. 4 will be mostly in the numerical format 4xx.

Headings may be included herein to aid in locating certain sections of detailed description. These headings should not be considered to limit the scope of the concepts described under any specific heading. Furthermore, concepts described in any specific heading are generally applicable in other sections throughout the entire specification.

As used herein, the term “substantially” in reference to a given parameter, property, or condition means and includes to a degree that one of ordinary skill in the art would understand that the given parameter, property, or condition is met with a small degree of variance, such as, for example, within acceptable manufacturing tolerances. By way of example, depending on the particular parameter, property, or condition that is substantially met, the parameter, property, or condition may be at least 90% met, at least 95% met, at least 99% met, or even 100% met.

Reference throughout this specification to “one embodiment,” “an embodiment,” or similar language means that a particular feature, structure, or characteristic described in connection with the indicated embodiment is included in at least one embodiment of the present disclosure. Thus, the phrases “in one embodiment,” “in an embodiment,” and similar language throughout this specification may, but do not necessarily, all refer to the same embodiment.

A “module” may mean a software process, a collection of software processes, a collection of hardware elements, or a combination thereof configured to implement one or more elements of the present disclosure.

Before describing specific embodiments, and in order to facilitate description in the present disclosure, various terms are described herein in relation to some embodiments. Where ambiguity may exist between the plain meaning, dictionary meaning, and the term as described herein, a person of ordinary skill in the art will recognize the term as described herein will best conform to a more comprehensive understanding of embodiments of the present disclosure.

A “one-time pad” (OTP) is an unbreakable encryption technique in which identical paired sets of key material are distributed to two communicants prior to their need for encrypted communication. When needed, a portion of the OTP is used by the sending communicant to encrypt a message and the matching portion is used by the receiving communicant to decrypt the message. In early implementations, OTPs were literal pads of paper with random single-letter substitutions, and after portions of one or more pages in the pad were used to encrypt a message the pages could be removed from the pad and destroyed to prevent decryption of the message by anyone other than the recipient with the matching pad.

A “Random Cipher Pad” (RCP) is similar to, but different from, an OTP according to embodiments of the present disclosure. The term RCP may be used as a generic term for various species of RCPs. An RCP is a collection, which may be a file, of truly random numbers, e.g., gathered from one or more “True Random Number Generators” (TRNGs) or from other random number sources. The use of the word “random” evokes the protection an OTP offers by alluding to the truly random nature of the cipher. Although the size of the RCPs could vary between instantiations, or perhaps even within a particular instantiation, RCPs in many instances are measured in kilobytes or even larger units.

An “RCP pool” is a collection of RCPs. In some embodiments, each RCP within an RCP pool may be identified by a number that is unique within that pool (e.g., a sequential integer). Globally Unique IDentifiers (GUIDs), each comprising a unique 128-bit number, may be used as identifiers such that careful construction of this number can guarantee global uniqueness within any particular system. Thus, in some embodiments, each RCP pool may be identified with a GUID or another addressing method. Moreover, while a simple sequential identifier may be used to identify each RCP within an RCP pool, a GUID, a hash of the RCP, or other type of unique identifier may be used instead to identify each RCP within an RCP pool.

A “True Random Number Generator” (TRNG) is a hardware device, and associated software if needed, used to generate truly random numbers from an unpredictable quantum or non-quantum physical process. Quantum examples of these processes include nuclear decay, photons transmitted through a partially transparent mirror, and fluctuations in vacuum energy. Non-quantum examples include thermal noise, clock drift, and radio frequency (RF) noise.

While embodiments of the disclosure are generally described with reference to truly random numbers and a TRNG, in other embodiments, other type of random number configurations and associated generators may be utilized.

A “True Random Number (TRN) pool” is a set of true random numbers generated by a TRNG hardware device, and associated software if needed. A quantum random number (QRN) pool is a species of a generic random number pool wherein the true random numbers in the pool are generated by a quantum process. The terms “set” and “pool” may be used interchangeably within this description. In other words, this description may use random number pool and random number set interchangeably and QRN pool and QRN set interchangeably. In addition, a random number pool may be configured as a pool of individually selectable and addressable RCPs such as the RCP pool described above. In some embodiments, any of these pools may be utilized to define the random number pool(s) discussed herein.

The terms “unencrypted,” “unencrypted data,” “unencrypted data structure,” “unencrypted message,” “clear text,” and “plain text” refer to data that is not encrypted.

The terms “encrypted,” “encrypted data,” “encrypted data structure,” “encrypted message,” and “cipher text” refer to data that has passed through an encryption process according to embodiments of the present disclosure. As a non-limiting example, encrypted data may be generated by performing a bitwise exclusive-OR (XOR) between a plain text message and a random number from a random number pool.

The terms “decrypted,” “decrypted data,” “decrypted data structure,” and “decrypted message” refer to data that was previously encrypted and has been returned to its original value. As a non-limiting example, decrypted data may be generated by performing a bitwise exclusive-OR between an encrypted message and the same random number from a random number pool that was used to encrypt the plain text message. Decrypted data may also be referred to as “clear text,” or “plain text.” Thus, plain text and clear text may refer to data before encryption or data after decryption.

The term “commutative” refers to a characteristic of the application of multiple RCPs in a manner that the order in which data is encrypted using multiple RCPs does not matter. In other words, as long as the same set of RCPs is used to encrypt and decrypt, using the RCPs in different orders for encryption and decryption will produce the same final result.

The term “pad” may be generically used herein to refer to an RCP according to embodiments of the present disclosure. In contrast, a conventional one-time pad is explicitly referred to as a conventional one-time pad or a one-time pad and not simply as a pad.

### Implementation Overview

Embodiments described herein facilitate utilization of Random Cipher Pads (RCPs), which may be somewhat similar to conventional one-time pads, but used in new and different ways. While RCPs may generally be utilized to encrypt information (e.g., documents, media streams, and data files) and/or other RCPs, embodiments of the present disclosure may include a first pool of RCPs (e.g., a pool of true random numbers generated by a TRNG) that are utilized to control (e.g., feed random control variables into) another random number device or pool of random numbers (e.g., a pseudo-random number device, a true random number device, an intermediate random number pool, etc.) in order to produce a second RCP pool (e.g., a relatively larger RCP pool) that may then be used for encryption and/or decryption. Such a resultant relatively larger RCP pool may be particularly useful in high-bandwidth applications, while still maintaining some of the security characteristics of RCPs generated directly by a random number generator.

Conventional one-time pad encryption is generally recognized as being unbreakable. Similarly, the use of RCPs is unbreakable under the condition that (1) the RCPs are securely distributed to the communication endpoints, or (2) a transfer process for generating and distributing additional RCPs is secure and unbreakable. Therefore, an endless number of RCPs can be securely used by the communicants as long as the RCPs can be securely developed and the used RCPs are rendered undiscoverable, unusable, unreadable, otherwise inaccessible, or destroyed.

Interception of the transmission generally will not help an intruder since RCP encryption cannot be broken. At worst, the intended recipient will not receive the transmission intended for him and will contact the sender, uncovering a theft or loss of information.

In some embodiments, the initial RCP exchange installation is done “outside” the electronic environment, or done in a highly secure manner with full authentication of sender and recipient. This results in a situation where each subsequent RCP cannot be decrypted and therefore cannot be intercepted for use.

Conventional one-time pads are currently not practical for ubiquitous use, or even enterprise use, because each pad is a singular event and the sender and recipient(s) must have an identical pad for each transmission. Identical pads are requisite for encryption and decryption. Heretofore, conventional one-time pads between sender and receiver were exchanged using Public Key Encryption (PKE), which is breakable. The use of PKE to “secure” exchange of pads is not secure, and increasingly vulnerable. Delivering a new pad manually (e.g., by mail or courier) for each new use may be impractical, costly, and inefficient; plus, the method of getting each successive pad into one or more recipients' hands may create vulnerabilities.

In situations where replenishment by manual methods is impractical or limited, the existing RCPs may be extended by utilizing the RCPs with another randomization process that greatly increases (e.g., by an order or orders of magnitude) the amount of resultant RCPs (e.g., which RCPs may be generated by an intermediate process controlled at least in part by the initial pool of RCPs) according to embodiments of the present disclosure.

The following aspects, presented in separate or cumulative embodiments, present functionality opportunities possible with RCP encryption methods or processes. In general and in some embodiments, one or more pools of RCPs may be used for data encryption and also used for replenishing the one or more pools. In other words:
1. An initial RCP pool may be provided (e.g., manually, electronically, dynamically over time, etc.) to a cryptographic system.
2. Data from the initial RCP may be utilized with a secondary cryptographic element (e.g., a pseudo-random process) to greatly extend the service life of the initial RCP pool over a select period of time and/or data throughput. For example, the resultant RCP pool may be utilized over a period of time with an amount of data that greatly exceeds the amount of time/data that the initial RCP pool would have been used, with the initial RCP pool directly encrypting/decrypting the data.

Stated another way, embodiments of the present disclosure include systems, apparatus, and methods for providing cryptographic procedures including utilizing portions of an RCP pool to control another separate random number generation process, which process may be synchronous on two or more computing devices or servers. These embodiments may assist in reducing and/or eliminating attack surfaces while still enabling large amounts of data to be processed before the initial RCP pool needs to be replenished.

In some embodiments, some or all of the encryption features described herein are implemented within a computer processor or processing device that executes the encryption procedures. The transformation of data that occurs according to the specific encryption techniques described herein render the processing device executing embodiments described herein as a special-purpose processing device capable of new functionality that is otherwise not available executing conventional software or logical procedures. Furthermore, efficient processing of such encryption procedures requires implementation within computer processing systems. Furthermore, the interactions between an electronic storage device to store data associated with the encryption techniques described herein and the computer processing devices to execute the encryption techniques described herein achieve much greater efficacy than would be possible through other non-computerized processes.

It is a characteristic of RCP encryption that if an exclusive-OR (XOR) operation is used to encrypt the data then applying the exclusive XOR a second time (with the same RCP data) will decrypt the data. Therefore, the encryption and decryption processes are similar. However, encryption and decryption are not restricted to the use of XOR as the encryption operator for the RCP encoder and decoder. Any suitable symmetric operation could be used.

In some embodiments, RCP generation takes place on the computer that has the greatest resources, either on the sender's computer or on the recipient's computer. In additional embodiments, the RCP development or generation may be performed by a third-party intermediary computer or reference computer (e.g., an RCP server) and delivered in a secure fashion to each of the computers wishing to communicate with each other over a secure channel.

RCP sizes may vary in different implementations, or even over different stages of the same communications stream between sender and receiver devices.

For ease of description, data elements are generally described in terms of “bytes.” However, a person of ordinary skill in the art will recognize that the data elements may be configured in many sizes suitable to different applications, such as, for example, 16-, 32-, or 64-bit words.

Embodiments of the present disclosure may enable generation of a given pool of key material being used for the 1) symmetric encryption/decryption (also referred to herein as symmetric cryptography) of user data or 2) symmetric cryptography of random data produced for dynamic replacement of key data used for symmetric cryptography of user data. Details of this symmetric cryptography for user data and dynamic replacement of key data may be found in U.S. patent application Ser. No. 15/134,260 filed Apr. 20, 2016 and entitled “Random Cipher Pad Cryptography” and U.S. patent application Ser. No. 16/637,806 filed Feb. 10, 2020 and entitled “Cryptographic Systems and Methods For Extending Apparent Size of Pools Of Truly Random Numbers,” the entire disclosure of each of which is hereby incorporated by reference in its entirety.

### Implementation Details

FIG. 1 is a block diagram of a cryptography system 100 using synchronized random number pools 125A, 125B with a communication channel 150 (e.g., a wired channel, such as data pipe, which may be a high-volume data pipe, a wireless channel, bidirectional tunnel, combinations thereof, etc.).

In some embodiments, the system in FIG. 1 may be configured as router-to-router (R2R) system. However, it should be understood that this system may use routers, servers, gateways, or other suitable devices for communicating with multiple clients, encrypting/decrypting client message traffic and sending/receiving encrypted messages through the communication channel 150. Embodiments using R2R hardware and/or software may act as a specialized solution for select applications where message traffic is being exchanged between many users in two distributed locations. Similarly, embodiments using servers on one or both ends include hardware and/or software as a specialized solution for select applications where server resources are used at one or both of the distributed locations. Encryption is applied at each router as traffic enters or departs. The routers become single endpoints, paired exclusively with each other and shared by many on either end. This system may be more appropriate for operations where both ends are contained within a secure environment because all traffic between senders and their corresponding router may be in plaintext and subject to exploitation if intercepted.

Embodiments of the present disclosure may include encryption solutions to autonomously and seamlessly encrypt data while under user control (e.g., within a firewall), transfer the data, and then decrypt the data (e.g., within another firewall) at the other end moving data back onto a computing device (e.g., server 110A, 110B) for distribution.

For example, as shown in FIG. 1, one or more computing devices (e.g., cryptography servers or devices 120A, 120B) may be located within an entity firewall 130A, 130B, such as, for example, a corporate firewall at each end of the communication channel 150. Depending on the flow of data, the computing devices may be broadly and non-limitingly labeled as a server or generic device; however, in some instances, these devices may effectively act as variations of a server and a client, one or more clients, or a sever and multiple clients. For example, cryptography server 120A may act as a server as it provides one or more RCPs to a cryptography server 120B as a client, and vice versa. By way of further example, cryptography servers 120A, 120B may act as clients to another main server that provides one or more RCPs (e.g., synchronous RCPs) to the cryptography servers 120A, 120B.

In some embodiments, the cryptography server 120 and the server 110 may be different physical servers or computing devices. In other embodiments, the cryptography server 120 and the server 110 may be configured as separate processes in communication with each other on a single physical hardware device.

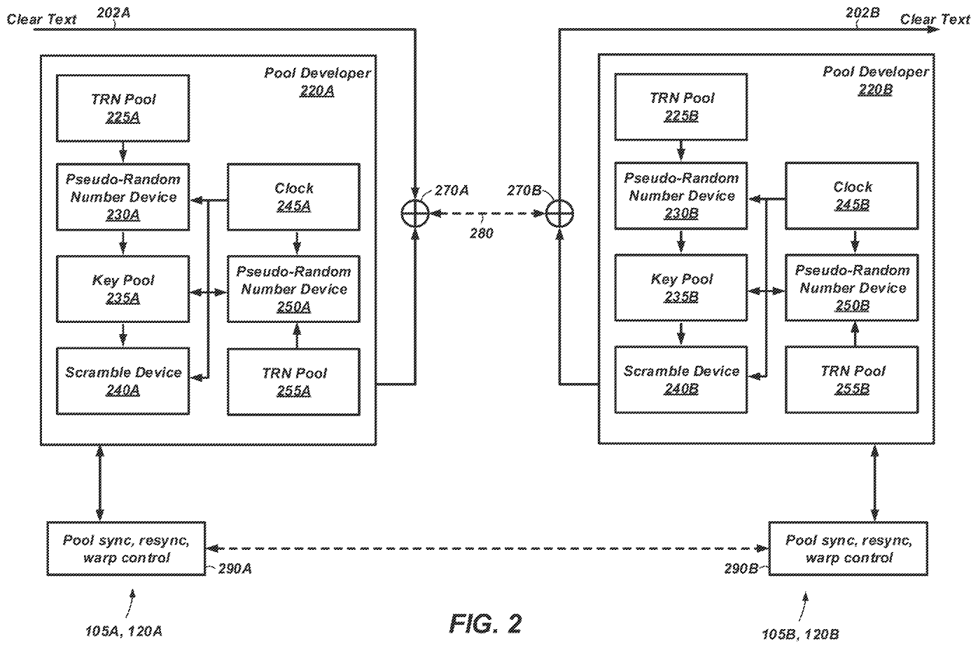

Element numbers in FIGS. 1 and 2 include an appended “A” or “B” to indicate similar blocks, modules, and functions on each side of a communication system. Thus, drawing elements may be referred to with their generic number without the appended “A” or “B” when describing functions that are similar on each end. Encryption may take place on the cryptography server 120 as one of the last operations when data leaves a sending device 105A before entering the communication channel 150. Conversely, decryption may take place on the cryptography server 120 as one of the first operations when data exits the communication channel 150 at a receiving device 105B. The cryptography server 120 may be coupled to the server 110, which collects plain text traffic to be encrypted on the sending device 105A or distributes plain text traffic to the designated recipient(s) after decryption on the receiving device 105B. Each cryptography server 120 is connected to or includes data storage which contains the RCP pool (e.g., a random number pool 125A, 125B that is produced using another true random number pool as discussed in detail below), one or more of which pools may be preloaded on each server 120. With embodiments of the present disclosure these pools 125 on each side are identical and can be synchronized to provide random numbers used as encryption keys and decryption keys. The pools 125 (e.g., the entire pool 125 and/or one or more RCP pools that are utilized to control population of the pools 125) may be replenished on a routine basis by an out-of-band key manager 160 supplied from a remote system and/or may be replenished by one or more of the servers 120 as discussed herein. Various high security features may be built into this system to prevent compromise on control or replenishment of the pools 125.

Embodiments of the present disclosure enable development (e.g., generation, replenishment, population, extension, etc.) of a given pool of key material elements being used for the symmetric cryptography of data. In developing a given pool of key material, random bytes of key material may be initially populated, provided, and/or replaced as the key material is utilized (e.g., in ongoing and/or periodic processes). As a result, embodiments of the present disclosure may be utilized to reach or approximate the security of a one-time pad where bytes are never reused and are replaced and shared securely between computing devices. Such embodiments are believed to be more secure than Private Key Infrastructure (PKI) encryption methods and may also be Quantum Proof.

FIG. 2 is a more detailed block diagram illustrating elements on the cryptography servers 120 using pools of key material elements (e.g., key or RCP pools 235A, 235B). In general, each cryptography server 120 operates in a similar manner except that one side is encrypting clear text data elements 202A as an input to an encryption operation 270A (e.g., a bitwise XOR) to create encrypted data elements 280 and the other side is decrypting the encrypted data elements 280 using a decryption operation 270B (e.g., a bitwise XOR) to create clear text data elements 202B as an output. Of course, communication is two-way and although encryption and transmission is shown from A to B (left to right) in FIG. 2, encryption and transmission will generally flow both directions and may flow through other devices (e.g., such as an encryption server managing communications and additional encryption between the endpoints).

A first copy 235A and a second copy 235B of the synchronized RCP pools 235A, 235B may be substantially identical and a pool sync/resync module 290 may be included to ensure that the same key material elements within the pools (e.g., synchronized RCP pool 235, TRN pools 225, 255) are selected and used at the same time on each side. In some embodiments, the pool sync/resync module 290 may be utilized to control the pool developer and related components that are detailed below.

Embodiments of the present disclosure may develop (e.g., generate, maintain, etc.) a given RCP pool 235A, 235B (e.g., a pool of key material or data) being used for symmetric cryptography by providing one or more pool developers 220A, 220B. The pool developers 220A, 220B may define a substantially random method of developing the random numbers (e.g., also referred to herein as key material elements, key data elements, or key elements) in the RCP pools 235 as an initial population of the RCP pools 235 or through replacement of the key material elements as the elements are utilized in an encryption and/or decryption process and retired (e.g., dynamic replenishment).

While FIG. 2 illustrates a pool developer 220 on each device or server 120, in other embodiments, one (or more) pool developers 220 may provide key material elements to one or both of the servers 120. For example, the pool developer 220 may be provided on an external server, where the servers 120 are supplied key material elements to respective RCP pools 235 (e.g., as clients). In additional embodiments, the pool developer 220 may only be provided one or more servers 120 where the pool developer 220 provides all initial and/or replenishment key material elements to the other servers 120, which may lack a pool developer 220.

The pool developer 220 provides one or more randomizing processes for developing key material elements for the synchronized RCP pool 235. In some embodiments, such processes may be substantially random in manner, but also reproducible, such that the sending device 105A and the receiving device 105B of FIG. 1 may stay in synchronization to produce and utilize the same key data elements from the RCP pools 235.

The pool developer 220 may include an initial pool of random numbers (e.g., a true random number (TRN) pool 225A, 225B populated by a true random number generator (TRNG)). In some embodiments, the initial TRN pools 225 would be delivered to each side in a secure manner, such as, for example, by trusted courier, tamper evident packaging, or other suitable secure communication channel. In additional embodiments, the TRN pools 225 may be populated by another server or through other dynamic processes.

The TRN pool 225 may be in communication with another random number generation device 230A, 230B (e.g., a pseudo-random number generator (PNRG)). Such a random number device 230A, 230B may include, for example, a linear feedback shift register (LFSR), a linear congruential generator (LCG), a well equidistributed long-period linear (WELL), middle square Weyl sequence PRNG, a Mersenne Twister, an XOR shift, combinations thereof, etc.

The pseudo-random number generator device 230 may produce random numbers as it progresses through its states, but with a pre-defined sequence. Key elements may be provided from (e.g., selected from) the TRN pool 225 as one or more number values (e.g., integer values, variables, etc.) for controlling the pseudo-random number generator device 230 (e.g., as one or more initialization parameters, one or more seed values, one or more initial values or vectors, one or more prime or primitive polynomial values, one or more tap values or taps, shift index, etc.). For example, the TRN pool 225 on each side may provide use initialization parameters to set the pseudo-random number generator device 230 on each side to the same initial state. From then on, as long as the pseudo-random number generator devices 230A, 230B on each side stay in synchronization, each subsequent state will produce the same pseudo-random number on each side.

With the initial value input for the TRN pool 225, the random number device 230 may output at least one RCP of key data elements, which may be stored in a RCP pool 235A, 235B (e.g., with other RCPs) or may be immediately provided for an encryption and/or decryption process. In some embodiments, a select size of RCP (e.g., 8 bytes, 16 bytes, 32 bytes, 64 bytes, 128 bytes, etc.) may be provided one-at-a-time from either the RCP pool 235 or directly from the random number device 230.

In some embodiments, the key data elements of the RCP pool 235 may be further randomized in a further process (e.g., a scramble device 240A, 240B, a randomizer, etc.). For example, the scramble device 240 may pseudo-randomly swap bit positions of the RCP before being used in an encryption and/or decryption process. In some embodiments, each scramble device 240 may be in communication another random number generator 250A, 250B (e.g., another a pseudo-random number generator (PNRG), such as another linear feedback shift register (LFSR)). Another random number generator 250 may be utilized to dictate which bits positions are swapped in a pseudo-random way, with a deterministic output such that the another random number generators 250A, 250B may be synchronized. For example, the other random number generator 250 may input a pseudo-random binary sequence (PRBS) into each of the scramble devices 240A, 240B, each starting from the same initial state, in order to keep the scramble devices 240A, 240B in synchronization.

In some embodiments, and similar to that discussed above, key elements may be provided from a TRN pool 255A, 255B as one or more number values (e.g., integer values, variables) for controlling the random number device 250 (e.g., one or more seed values, one or more initial values or vectors, one or more prime or primitive polynomial values, one or more tap values or taps). For example, the TRN pool 255 on each side may provide and/or use initialization parameters to set the pseudo-random number generator device 250 on each side to the same initial state. From then on, as long as the pseudo-random number generator devices 250A, 250B on each side stay in synchronization, each subsequent state will produce the same pseudo-random number on each side.

A clock 245A, 245B may be used to ensure that one or more components of the pool developer 220 stay in synchronization. For example, the clock 245 may be in communication with the pseudo-random number generators 230, 250, the RCP pool 235, and/or the scramble device 240 in order to synchronize processes within each pool developer 220A, 220B and/or to synchronize multiple separate pool developers 220A, 220B. In some embodiments, the clock 245 may provide timing for the pool sync/resync module 290 to synchronize, initialize, and/or resynchronize the pseudo-random number generators 230, 250, the RCP pool 235, and/or the scramble device 240 as needed.

In some embodiments, each clock 245 event may cause the scramble device 240 to select a scramble level (e.g., as defined by 2ⁿ, the number of bit positions being randomly swapped, where n equals the selected level) and may cause a string of bits to be provided from the pseudo-random number generator 250 to control the random swapping of the RCP by the scramble device 240 at the current level. For example, 64 bytes of RCP may be scrambled by the scramble device 240, 64 bytes or 512 bits at a time. The scramble device 240 may utilize nine levels (e.g., 2ⁿ, the number of bits, where n equals the current level, 0 through 8, as dictated by the clock 245). Each clock event may provide a corresponding amount of bits (e.g., 511 bits) from the pseudo-random number generator 250 to dictate the pseudo-random inverting of the RCP by the scramble device 240 at each level.

However, the pool developer 220 may only provide a clock 245 event to the pseudo-random number generator 230 and/or the RCP pool 235 at select intervals of the clock 245 or the pseudo-random number generator 230 and/or the RCP pool 235 may only act at certain intervals of the clock 245. For example, the pseudo-random number generator 230 and/or the RCP pool 235 may only produce or provide an RCP at a select number of clock 245 events. Following the example above, a 64-byte RCP is scrambled by the scramble device 240 for nine clock 245 events (e.g., for the nine levels). Thus, the pseudo-random number generator 230 and/or the RCP pool 235 may only produce or provide another 64-byte RCP at an interval of nine clock 245 events. It is understood that the specific example above is for illustrative purposes only and any other variations between scramble levels and RCP production/provision may be implemented as is appropriate for any given application.

As indicated, a warping feature may optionally be included in some embodiments in the pool sync/resync module 290 or otherwise. There may be cases where an unauthorized internal or external actor is able to obtain a copy of RCPs or the RCP pool(s) by some means or able to otherwise ascertain contents of the RCP pool. There may be other cases where the client desires to modify the RCP pools after the RCP pools have been provided by a developer of the RCP pools (e.g., in case data of the developer is compromised or is otherwise ascertained by third parties). Some embodiments may enable a process for performing a user-specific modification of the RCP pool (also referred to herein as warping or performing a warp operation). Once the warp has been implemented, only the client users will be able to decrypt any traffic. At that point, the RCP provider has irrevocably turned total and complete control of the key data elements in the RCP pool over to the client. Examples of such a warping proceeding are disclosed in, for example, U.S. Provisional Patent Application Ser. No. 62/617,984, filed Jan. 16, 2018 and entitled “Cryptographic Systems and Methods for Modification of Pools of Truly Random Numbers,” the disclosure of which is hereby incorporated herein in its entirety by this reference.

As discussed above, embodiments of the present disclosure may produce an extended RCP pool by using a first or initial pool of key elements (e.g., true random number elements) to provide control (e.g., provide values, such as initial operational parameters) to a second random number device (e.g., a pool of random numbers and/or a random number generator). Such a random number device (e.g., a pseudo-random number generator) may produce strings of random numbers that may be synchronized over two or more computing devices where the output of the random number device may be at least partially known or predictable given a number of known values. The resultant pool (e.g., strings of random numbers) may later be used for symmetric cryptography of user data.

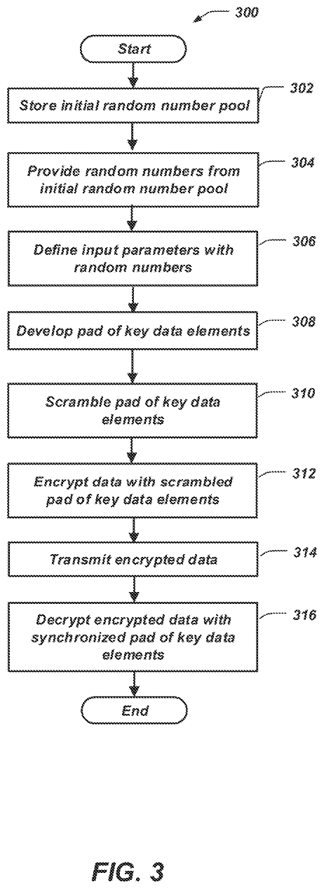

FIG. 3 illustrates processes for producing and/or replenishing a random number pool. As discussed above, in some embodiments, the following acts may be performed on two or more computing devices or systems in a substantially synchronous manner. In additional embodiments, the acts may be performed on a single computing device or server with the resulting key material being provided to two or more computing devices or systems as clients.

As shown in FIG. 3, process 300 begins at process block 302 where an initial random number pool is stored on one or more computing systems (e.g., two or more synchronized systems, one system that provides key material to other computing systems or devices, etc.). For example, a first copy of the initial random number pool on a first computing system may substantially match and be synchronized with a second copy of an initial random number pool on a second computing system. As discussed above, the initial random number pool may comprise true random numbers (TRN) that may be provided by a true random number generator (TNRG).

At process block 304, a set (e.g., pad, array) of random numbers from the initial random number pool may be delivered (e.g., as metadata) to a downstream random number generator or pool. The downstream random number generator or pool may comprise a pseudo-random number generator, such as, for example, a linear feedback shift register (LFSR).

At process block 306, the set of random numbers may be utilized to define one or more variables relating to an output of the downstream random number generator. For example, the set and/or array of random numbers may provide input parameters (e.g., initial values or vectors, such as, polynomials, prime or primitive polynomials, taps, etc.) for defining an operational state of the downstream random number generator or pool. Where two or more synchronous devices or systems are implemented, the input parameters may ensure that the downstream random number generator or pool on each device or system operates in a synchronous manner.

At process block 308, a first set (e.g., pad) of key data elements may be developed with the output of the downstream random number generator and may be stored as a pad of a select size or in a pool of such pads. The first set of key data elements may substantially match a second set of key data elements developed on the second computer.

At process block 310, the pad of key data elements may be provided (e.g., in a pad having a selected size or grouping) to a randomization process (e.g., a scramble device). For example, the first set of key data elements may be scrambled by a scramble device before utilizing the group of key data elements in an encryption and/or decryption process. In some embodiments, the scramble device may comprise an additive scramble device utilizing another random number generator (e.g., a pseudo-random number generator, such as, for example, a linear feedback shift register (LFSR)) to input a pseudo-random binary sequence (PRBS) into the scramble device in order to dictate the bit position swapping. As the scrambled pad of key elements is the end product for encryption and/or decryption on the synchronized computing devices, the same scrambling process is always necessary on the corresponding decryption and/or encryption device.

As above, another pool of random numbers (e.g., a TRN pool) may be utilized to feed input parameters into the pseudo-random number generator (e.g., in order to keep multiple pseudo-random number generator operating in a synchronous manner.

As discussed above, one or more of the devices (e.g., the scramble device, the LFSRs, the set of random numbers (e.g., stored as a pad a select size or a pool of such pads) may be synced with one or more clock devices in order to keep the process in synchronization (e.g., internally and with other computing device(s)).

At process block 312, the pad of key data elements may be utilized to encrypt and/or decrypt data. By way of example, a process of encryption on a first device and decryption on a synchronized device is discussed. Data is encrypted on a sending computing device utilizing the pad of key material elements. The data may be clear text data (e.g., user data, user messages) to be encrypted and/or key material elements to be encrypted.

As noted above, the pad of key elements may be provided in sections (e.g., data chunks of a predetermined size). Pad sections or chunks may continue to be supplied based on the size of the data to be encrypted. For example, such sections or chunks may be provided dynamically (e.g., repeating process blocks 306 through 312, repeating process blocks 310 and 312 where the pads are stored in a pool after being developed by the first LFSR, combinations thereof, etc.) until all of the data has been encrypted (e.g., when the size of the key elements is equal or greater than the size of the data encrypted). In additional embodiments, the pad of key elements may be available in a pool at another location of the pool developer process (e.g., after the pad of key elements has been developed and scrambled).

In some embodiments, prior to encryption, the data (e.g., clear text received from a user) may undergo an initial obfuscation process (e.g., an initial randomization and/or cryptographic process). For example, the data may be processed via a substitution-permutation network-type process (e.g., the S-box step of the advanced encryption standard (AES) process). In such a configuration, bytes of the data may be replaced with another Byte using one or more locations of a substitution box (e.g., one or more S-boxes).

In some embodiments, the initial encryption may be varied or randomized, such that the initial obfuscation will differ during an encryption process and/or between encryption processes. For example, a number of varying S-boxes may be provided (e.g., via the metadata) such that particulars of the initial encryption process of the data may vary during one encryption process and/or between subsequent processes.

In additional embodiments, other type of randomization and/or cryptographic processes may be utilized to initially alter the supplied data before the data is encrypted.

At process block 314, the encrypted data may then be transmitted to a receiving computing device.

At process block 316, the encrypted data may be decrypted by the receiving computing device using a synchronized pad of key material that has been developed locally on the receiving computing device (e.g., using substantially the same process blocks 302 through 310) or that has been developed remotely and securely provided to the receiving computing device. For example, pads of key elements for decryption may be provided in sections (e.g., data chunks of a predetermined size). Pad sections or chunks (e.g., stored locally and/or produced dynamically as above) may continue to be supplied based on the size of the data to be decrypted.

In embodiments where the data underwent an initial obfuscation process prior to encryption, a similar process may be applied to the now decrypted data that still includes the initial encryption. As above, a corresponding process (e.g., an inverse S-box selected from a group of provided S-boxes) may be utilized to further decrypt the data by removing the initial encryption (e.g., resulting in clear text).

The above process may be repeated as necessary for further pad development and encryption/decryption processes.

In some embodiments, it is believed the use of pseudo-random number generator devices being controlled by a true random number pool may approach or obtain perfect secrecy as defined Shannon's mathematical proof. The resulting pool and/or pad of random numbers may be shown to approach or obtain uniform distribution even after the additional processing by the pseudo-random number generator devices.

For example, when one or more LSFRs are implemented, the LFSR taps may be based on primitive polynomials, where the LFSR cycles through all possible numeric values except zero. Such output produces the maximum number of values possible that are uniformly distributed across a sample space. The randomness properties of LFSRs based on primitive polynomials have been mathematically proven to have substantially the same statistical properties as true random number generators. For example, relatively large LFSRs (e.g., 1024-bit) would include a number of primitive polynomials so large that it would be extremely unlikely, if not impossible, to decipher the resulting random number pads and/or pools, even when using a quantum computer. The choice of LFSR bits tapped for feeding into a scrambling function and the RCP lookup function also adds difficulty in determining and obfuscates what RCP values are used.

FIG. 4 illustrates a computing system 400 for practicing embodiments of the present disclosure. As non-limiting examples, the computing system 400 may be a user-type computer, a file server, a compute server, a notebook computer, a tablet, a handheld device, a mobile device, or other similar computing system for executing software. Computer, computing system, and server may be used interchangeably herein to indicate a system for practicing embodiments of the present disclosure. The computing system 400 is configured for executing software programs containing computing instructions and includes one or more processors 410, memory 420, storage 430, user interface elements 440, and one or more communication elements 450. Some embodiments of the computing system 400 may include one or more random number generators 460 as explained more fully above in connection with FIGS. 1 through 3.

The one or more processors 410 may be configured for executing a wide variety of operating systems and applications including computing instructions for carrying out embodiments of the present disclosure.

The memory 420 may be used to hold computing instructions, data structures, and other information for performing a wide variety of tasks including performing embodiments of the present disclosure. By way of example, and not limitation, the memory 420 may include Static Random-Access Memory (SRAM), Dynamic Random-Access Memory (DRAM), Read-Only Memory (ROM), FLASH memory, EEPROM, and the like.

The memory 420 may include other types of memory devices, including volatile storage devices or non-volatile storage devices, configured to store information. Examples of other types of memory 420 include nano RAM or (NRAM), nanocrystal wire-based memory, silicon-oxide based sub-10 nanometer process memory, graphene memory, Silicon-Oxide-Nitride-Oxide-Silicon (SONOS), Resistive random-access memory (RRAM), programmable metallization cell (PMC), conductive-bridging RAM (CBRAM), magneto-resistive RAM (MRAM), phase change RAM (PCRAM), phase change memory, or other solid-state storage media.

The storage 430 may be used for storing relatively large amounts of non-volatile information for use in the computing system 400 and may be configured as one or more storage devices. By way of example, and not limitation, these storage devices may include computer-readable media (CRM). This CRM may include, but is not limited to, magnetic and optical storage devices such as disk drives, magnetic tapes, optical storage drives such as CDs (compact disks), DVDs (digital versatile discs or digital video discs), and other equivalent storage devices.

Information related to the computing system 400 may be presented to, and received from, a user with one or more user interface elements 440. As non-limiting examples, the user interface elements 440 may include elements such as displays, keyboards, mice, joysticks, haptic devices, microphones, speakers, cameras, and touchscreens. A display on the computing system may be configured to present a graphical user interface (GUI) with information about the embodiments of the present disclosure.

The communication elements 450 may be configured for communicating with other devices or communication networks. As non-limiting examples, the communication elements 450 may include elements for communicating on wired and wireless communication media, such as for example, serial ports, parallel ports, Ethernet connections, universal serial bus (USB) connections, IEEE 1394 (“firewire”) connections, lightning connections, thunderbolt connections, Bluetooth wireless connections, 802.1 a/b/g/n type wireless connections, cellular phone connections, TCP/IP, FTP, HTTP, and other suitable communication interfaces and protocols.

Software processes illustrated herein are intended to illustrate representative processes that may be performed by the systems illustrated herein. Unless specified otherwise, the order in which the process acts are described is not intended to be construed as a limitation, and acts described as occurring sequentially may occur in a different sequence, or in one or more parallel process streams. It will be appreciated by those of ordinary skill in the art that many steps and processes may occur in addition to those outlined in flow charts. Furthermore, the processes may be implemented in any suitable hardware, software, firmware, or combinations thereof.

By way of non-limiting example, computing instructions for performing the processes may be stored on the storage 430, transferred to the memory 420 for execution, and executed by the processors 410. The processors 410, when executing computing instructions configured for performing the processes, constitutes structure for performing the processes and can be considered a special-purpose computer when so configured. In addition, some or all portions of the processes may be performed by hardware specifically configured for carrying out the processes.

Many of the functional units described in this specification may be labeled as modules, threads, or other segregations of programming code, in order to more particularly emphasize their implementation independence. Modules may be at least partially implemented in hardware, in one form or another. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices, or the like.

Modules may also be implemented using software, stored on a physical storage device 430 (e.g., a computer readable storage medium), in memory 420, or a combination thereof for execution by various types of processors.

An identified module of executable code may, for instance, comprise one or more physical or logical blocks of computer instructions, which may, for instance, be organized as a thread, object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several storage 430 or memory 420 devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network. Where a module or portions of a module are implemented in software, the software portions are stored on one or more physical devices, which are referred to herein as computer readable media.

In some embodiments, the software portions are stored in a non-transitory state such that the software portions, or representations thereof, persist in the same physical location for a period of time. Additionally, in some embodiments, the software portions are stored on one or more non-transitory storage devices, which include hardware elements capable of storing non-transitory states and/or signals representative of the software portions, even though other portions of the non-transitory storage devices may be capable of altering and/or transmitting the signals. One example of a non-transitory storage device includes a read-only memory (ROM) that can store signals and/or states representative of the software portions for a period of time. However, the ability to store the signals and/or states is not diminished by further functionality of transmitting signals that are the same as or representative of the stored signals and/or states. For example, a processor may access the ROM to obtain signals that are representative of the stored signals and/or states in order to execute the corresponding software instructions.

While the present disclosure has been described herein with respect to certain illustrated embodiments, those of ordinary skill in the art will recognize and appreciate that the present disclosure is not so limited. Rather, many additions, deletions, and modifications to the illustrated and described embodiments may be made without departing from the scope of the disclosure as hereinafter claimed along with their legal equivalents. In addition, features from one embodiment may be combined with features of another embodiment while still being encompassed within the scope of the disclosure as contemplated by the inventor.

1. A computer-implemented method for performing cryptographic procedures, comprising:
storing a first copy of an initial random number pool on a first computing system, wherein the first copy of the initial random number pool on the first computing system substantially matches and is synchronized with a second copy of an initial random number pool on a second computing system;
delivering a set of random numbers from the first copy of the initial random number pool to a downstream random number generator;
utilizing the set of random numbers to define one or more variables relating to an output of the downstream random number generator; and
developing a first set of key data elements with the output of the downstream random number generator, wherein the first set of key data elements substantially matches a second set of key data elements developed on the second computing system.

2. The computer-implemented method of claim 1, further comprising:
combining clear text data elements with the first set of key data elements using an encryption operation to produce encrypted data elements; and
transmitting the encrypted data elements to the second computing system.

3. The computer-implemented method of claim 2, further comprising:
delivering a second set of random numbers from the second copy of the initial random number pool to a downstream second random number generator;
utilizing the second set of random numbers to define one or more variables relating to an output of the downstream second random number generator; and
developing the second set of key data elements with the output of the downstream second random number generator.

4. The computer-implemented method of claim 3, further comprising decrypting the encrypted data elements with the second set of key data elements from the second computing system.

5. The computer-implemented method of claim 2, further comprising initially obfuscating the clear text data elements in an initial randomization process prior to the combining of the clear text data elements with the first set of key data elements.

6. The computer-implemented method of claim 1, further comprising selecting the set of random numbers from the first copy of the initial random number pool to comprise a set of true random numbers developed by a true random number generator.

7. The computer-implemented method of claim 1, further comprising selecting the downstream random number generator to comprise a linear feedback shift register (LFSR).

8. The computer-implemented method of claim 7, further comprising inputting the set of random numbers into the downstream random number generator to define at least one of one or more selectable taps, one or more initial vectors or parameters, one or more prime polynomials, or a shift index.

9. The computer-implemented method of claim 1, further comprising scrambling with a scramble device the first set of key data elements before utilizing the first set of key data elements in an encryption and/or decryption process.

10. The computer-implemented method of claim 9, further comprising inputting a pseudo-random binary sequence (PRBS) into the scramble device with a linear feedback shift register (LFSR) during the scrambling of the first set of key data elements.

11. The computer-implemented method of claim 1, further comprising maintaining a substantially uniform distribution in the first set of key data elements and the second set of key data elements.

12. A computer-implemented method for performing cryptographic procedures, comprising:
on a sending device:
storing a true random number pool on the sending device;
delivering a set of random numbers from the true random number pool to a first pseudo-random number generator;
utilizing the set of random numbers to define one or more variables relating to an output of the first pseudo-random number generator;
developing a first set of key data elements with the output of the first pseudo-random number generator;
combining clear text data elements with the first set of key data elements using an encryption operation to produce encrypted data elements; and
transmitting the encrypted data elements;
on a receiving device:
receiving the encrypted data elements;
providing a second set of key data elements on the receiving device, wherein the first set of key data elements on the sending device substantially matches the second set of key data elements on the receiving device; and
decrypting the encrypted data elements with the second set of key data elements.

13. The computer-implemented method of claim 12, further comprising, on the receiving device:
storing another true random number pool, wherein the another initial random number pool substantially matches the true random number pool;
delivering a second set of random numbers from the another initial random number pool to a second pseudo-random number generator;
utilizing the second set of random numbers to define one or more variables relating to an output of the second pseudo-random number generator; and
developing the second set of key data elements with the output of the second pseudo-random number generator.

14. The computer-implemented method of claim 12, further comprising outputting strings of random numbers with the first pseudo-random number generator comprising a linear feedback shift register (LFSR).

15. The computer-implemented method of claim 14, further comprising scrambling at least one of the first set of key data elements or the second set of key data elements before use in an encryption and/or decryption process with a second linear feedback shift register (LFSR).

16. The computer-implemented method of claim 14, further comprising utilizing another set of true random numbers from another true random number pool to define one or more variables relating to an output of the second linear feedback shift register (LFSR).

17. The computer-implemented method of claim 12, further comprising, on the sending device, initially encrypting the clear text data elements in an initial process prior to the combining of the clear text data elements with the first set of key data elements and, on the receiving device, further decrypting the encrypted data with an inverse process of the initial process after the decrypting of the encrypted data elements with the second set of key data elements.

18. A computing system configured for performing cryptographic procedures, the computing system comprising:
memory configured for storing computing instructions; and
a processor operably coupled to the memory for performing the computing instructions to:
store a true random number pool on the computing system;
deliver a set of random numbers from the true random number pool to a pseudo-random number generator;
utilize the set of random numbers to define one or more initial parameters of the pseudo-random number generator;
develop a set of key data elements with an output of the pseudo-random number generator;
combine clear text data elements with the set of key data elements using an encryption operation to produce encrypted data elements; and
transmitting the encrypted data elements to another computing system including a synchronized set of key data elements substantially matching the set of key data elements on the computing system.

19. The computing system of claim 18, wherein the system includes the another computing system comprising additional memory configured for storing additional computing instructions and another processor operably coupled to the memory for performing the additional computing instructions to:
store another true random number pool on the another computing system;
deliver another set of random numbers from the another true random number pool to another pseudo-random number generator;
utilize the another set of random numbers to define one or more initial parameters of the another pseudo-random number generator; and
develop a synchronized set of key data elements with the another pseudo-random number generator.

20. The computing system of claim 19, wherein the another random number pool comprises a substantial copy of the random number pool on the computing system.

21. The computing system of claim 19, wherein the additional computing instructions are further to decrypt the encrypted data elements with the synchronized set of key data elements.

22. The computing system of any one of claim 18, wherein the pseudo-random number generator comprises a linear feedback shift register (LFSR).

23. The computing system of claim 20, further comprising a second linear feedback shift register (LFSR) for scrambling at least one of the set of key data elements or the synchronized set of key data elements before use in an encryption and/or decryption process.

24. The computing system of any one of claim 18, wherein computing instructions are further to maintain a substantially uniform distribution in the set of key data elements.
